(19) United States
(12) Patent Application Publication
(10) Pub. No.: US 2018/0313716 A1
(43) Pub. Date: Nov. 1, 2018

(54) COMPOSITION FOR HIGHLIGHTING THE WIPING DEFECTS OF A WIPER BLADE AND METHOD FOR DETERMINING THE STATE OF WEAR OF A WIPER BLADE USING SUCH A COMPOSITION

(71) Applicant: Valeo Systèmes d'Essuyage, Le Mesnil Saint Denis (FR)

(72) Inventors: Olivier Jomard, Issoire (FR); Eric Poton, Issoire (FR); Marc Senaux, Issoire (FR); Antoine Boilevin, Bobigny (FR); Felix Marquette, Bobigny (FR); Stephane Ballanger, Saint-Denis (FR); Emeric Bailleul, Saint-Denis (FR); Guillaume Ingold, Saint-Denis (FR); Maria Pelissero, Saint-Denis (FR)

(73) Assignee: Valeo Systèmes d'Essuyage, Le Mesnil Saint Denis (FR)

(21) Appl. No.: 15/964,919

(22) Filed: Apr. 27, 2018

(30) Foreign Application Priority Data
Apr. 28, 2017 (FR) 1753819

(51) Int. Cl. G01M 3/20; C09K 11/02; G01N 21/64; G01M 3/02

(52) U.S. Cl. CPC G01M 3/20; G01M 3/027; G01N 21/6447; C09K 11/025

(57) ABSTRACT

The present invention relates to a composition (1) which makes it possible to show the wiping defects (3) of a wiper blade (5), in particular for a motor vehicle (7), in order to determine the state of wear of the wiper blade (5), the said composition (1) which makes it possible to show the wiping defects (3) being intended to be deposited as a layer on a windscreen (9) of the said motor vehicle (7), characterized in that the composition (1) which makes it possible to show the wiping defects (3) comprises a tracer compound (11) which makes it possible to bring to light the wiping defects (3) of the wiper blade (5) and exhibits:
a density of between 0.75 and 1.25 at 20° C., and
a viscosity of between 0.001 and 1.5 Pa·s at 20° C.

The present invention relates to the field of means for wiping the windows of motor vehicles. More specifically, the present invention relates to a composition which makes it possible to detect the wiping defects of wiper blades in order to determine their state of wear. Furthermore, another subject-matter of the present invention is a method for determining the state of wear of a wiper blade employing this composition.

Wiper blades are wearing parts of a motor vehicle which it is necessary to regularly replace if it is desired to guarantee good quality of wiping of the window. This proves to be especially particularly important for driving safety when it concerns a wiper blade of the windscreen of the motor vehicle.

There are many sources of wear of the wiper blade and the latter is capable of degrading in particular at the blade rubber. This is because wiper blades are generally formed by an elastomer material which will deteriorate over time. The blade rubber can, for example, wear out because of the rubbing actions of the latter over the window to be wiped but it can also wear out as a result of the detrimental change in the elastomer material of which it is composed.

The degradation of the blade rubber is generally observed by the user of the motor vehicle when the wiper blades are used. This is because, when the blade rubber wears out, the latter leaves wiping marks which may be harmful to the visibility and thus to the driving safety when it rains, for example. These wiping marks are generally due to cracks which are formed in the blade rubber or to tears of the elastomer material making up the wiper blade, mainly due to the rubbing actions of the blade rubber over the window to be wiped or also to twisting actions related to the movement of the wiper blades during the operation thereof, but also to some environmental factors, such as, for example, oxidation.

Generally, it is recommended to change the wiper blades every year. However, motorists are generally incapable of remembering when the last time was when they changed the wiper blades. This is because such an operation is not generally entrusted to a specialist in motor vehicle repair who might, for example, systematically and regularly replace the wiper blades. Furthermore, depending on the use of the motor vehicle and its parking conditions, for example, the detrimental change in the wiper blades may be faster or slower. Thus, it appears necessary to succeed in easily determining the need to replace the wiper blades in order to guarantee good conditions of visibility when it rains, for example.

It is an objective of the present invention to provide, in particular to specialists in motor vehicle repair, a product which makes it possible to easily detect the need to replace the wiper blades.

Another objective of the present invention is to provide, in particular to specialists in motor vehicle repair, a method which makes it possible to easily detect the need to replace the wiper blades.

To this end, in order to at least partially achieve at least one of the abovementioned objectives, a subject-matter of the present invention is a composition which makes it possible to show the wiping defects of a wiper blade, in particular for a motor vehicle, in order to determine the state of wear of the wiper blade, the said composition which makes it possible to show the wiping defects being intended to be deposited as a layer on a windscreen of the said motor vehicle, the composition which makes it possible to show the wiping defects comprising a tracer compound which makes it possible to bring to light the wiping defects of the wiper blade and which exhibits:
a density of between 0.75 and 1.25 at 20° C., and
a viscosity of between 0.001 and 1.5 Pa·s at 20° C.

“Tracer compound” is understood to mean an element which can be identified visually, such as a coloured or phosphorescent chemical compound, mixed with other compounds, which makes it possible to trace and monitor visually traces of residues present on the windscreen, in particular after wiper blades have passed.

The tracer compound of the composition according to the invention makes it possible to visually monitor, on the windscreen, the quality of wiping of the wiper blades and thus their degree of wear.

This is because the composition according to the invention is deposited on the windscreen and, after this composition has been swept away by the wiper blades, the presence of the composition not swept away by the blades on the windscreen, which is detected visually by means of the tracer compound, reveals the state of wear of the wiper blades.

Preferably, the degree of wear of the blades is proportional to the amount of the remaining composition on the windscreen after sweeping.

The use of a composition exhibiting such physicochemical characteristics allows the composition to be deposited on the windscreen of the motor vehicle and to be swept away by the wiper blades and in particular by their blade rubber. However, if this blade rubber exhibits traces of wear, such as cracks, for example, the composition remains on the windscreen at the point of passage of the trace of wear of the blade rubber, thus making it possible to easily demonstrate the need to replace the wiper blades. More specifically, such physicochemical characteristics make it possible to prevent any sliding by gravity of the composition over the windscreen of the motor vehicle. This composition thus makes possible easy and rapid monitoring of the state of wear of the wiper blades. Furthermore, this composition can just as easily be used by a specialist in motor vehicle repair as by any other person who is a stranger to the field of motor vehicle repair.

The composition which makes it possible to demonstrate the wiping defects according to the present invention can additionally comprise one or more of the following characteristics, taken alone or in combination.

According to a first alternative form, the tracer compound is a liquid.

According to this first alternative form, the tracer compound is a fluorescent liquid.

Advantageously, the liquid is fluorescent when it is irradiated with light rays having wavelengths lying within the ultraviolet region and preferably having wavelengths of between 315 nm and 400 nm.

According to a second alternative form, the tracer compound is a powder.

According to this second alternative form, the tracer compound is an opaque or coloured powder when it is irradiated with light rays having wavelengths lying in the visible region.

Advantageously, the tracer compound exhibits a particle size of less than 1 μm, preferably of less than 500 nm, and more preferably of between 1 nm and 250 nm.

Alternatively, the tracer compound is a foam.

Advantageously, the tracer compound is biodegradable.

According to a specific embodiment, the composition which makes it possible to show the wiping defects is present in an aerosol.

The present invention also relates to a method for determining the state of wear of a wiper blade comprising the following stages:
deposition of a composition which makes it possible to show the wiping defects on the windscreen of the motor vehicle as defined above,
actuation of the wiper blades of the motor vehicle, so that they carry out at least one to-and-fro movement over the windscreen, and
verification of the presence of traces, showing the wiping defects, left by the wiper blades on the windscreen of the motor vehicle.

Advantageously, the method additionally comprises a prior stage of cleaning the windscreen of the motor vehicle, the said prior cleaning stage been carried out before the deposition stage.

According to a first alternative form, the composition which makes it possible to show the wiping defects comprises a tracer compound in the form of a fluorescent liquid and the method additionally comprises a stage of irradiation at least of a detection region of the windscreen of the motor vehicle in order to activate the fluorescence of the tracer compound.

According to this first alternative form, the irradiation stage is carried out using a lamp which emits radiation having wavelengths lying in the ultraviolet region, and preferably of between 315 nm and 400 nm.

Advantageously, according to this first alternative form, the method moreover comprises an additional stage in which the motor vehicle is placed in a dark room in order to carry out the stage of irradiation of the windscreen of the motor vehicle in order to detect the tracer compound.

According to a second alternative form, the composition which makes it possible to show the wiping defects comprises a tracer compound in the form of a powder and the stage of verification of the presence of traces is carried out in direct visual fashion after the stage of actuation of the wiper blades of the motor vehicle.

According to a third alternative form, the composition which makes it possible to show the wiping defects comprises a tracer compound in the form of a foam and the stage of verification of the presence of traces is carried out in direct visual fashion after the stage of actuation of the wiper blades of the motor vehicle or by irradiation of at least one detection region of the windscreen of the motor vehicle in order to activate the fluorescence of the tracer compound.

According to this third alternative form, the irradiation stage is carried out using a lamp which emits radiation having wavelengths lying in the ultraviolet region, and preferably of between 315 nm and 400 nm.

The method additionally comprises a final stage of cleaning the windscreen of the motor vehicle, the said final stage being carried out after the stage of verification of the presence of traces.

Other advantages and characteristics of the invention will become more clearly apparent on reading the following description, given by way of illustration and without limitation, and the appended drawings, in which:

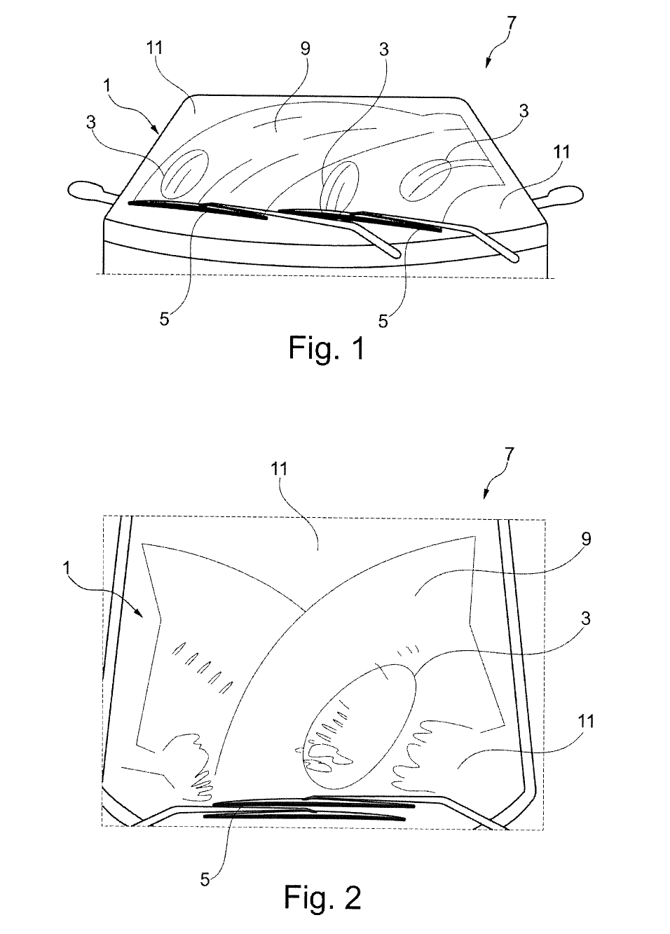

FIG. 1 is a diagrammatic front representation of a windscreen of a motor vehicle after passage of the wiper blades, on which windscreen a composition which makes it possible to show the wiping defects according to a first embodiment was initially deposited,

FIG. 2 is a diagrammatic front representation of a windscreen of a motor vehicle after passage of the wiper blades, on which windscreen a composition which makes it possible to show the wiping defects according to a second embodiment was initially deposited,

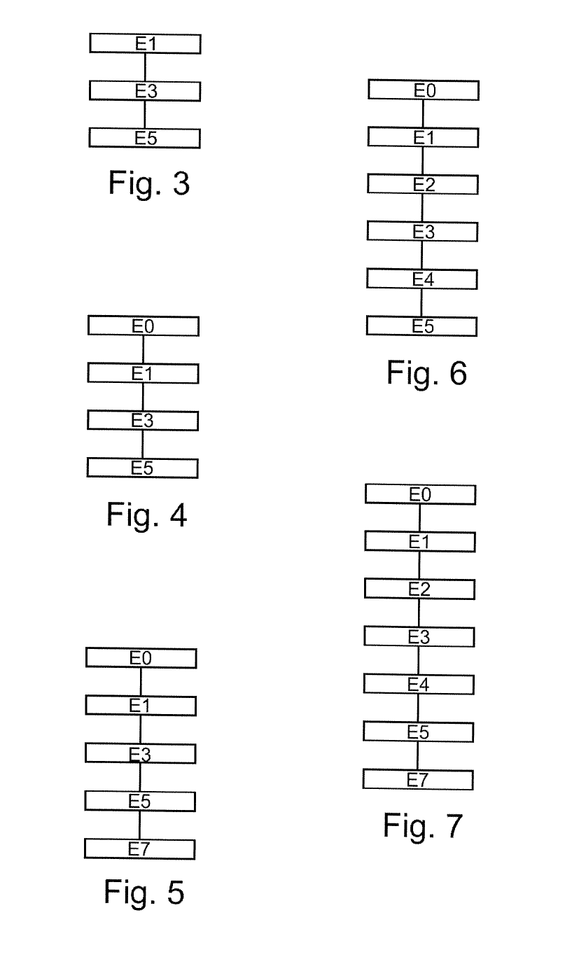

FIG. 3 is a block diagram illustrating a method for determining the state of wear of a wiper blade according to the invention,

FIG. 4 is a block diagram illustrating a method for determining the state of wear of a wiper blade according to a first embodiment,

FIG. 5 is a block diagram illustrating a method for determining the state of wear of a wiper blade according to a second embodiment,

FIG. 6 is a block diagram illustrating a method for determining the state of wear of a wiper blade according to a third embodiment, and

FIG. 7 is a block diagram illustrating a method for determining the state of wear of a wiper blade according to a fourth embodiment.

In these figures, identical elements carry the same numerical references.

The following implementations are examples. Although the description refers to one or more embodiments, this does not necessarily mean that each reference relates to the same embodiment, or that the characteristics apply only to just one embodiment. Simple characteristics of different embodiments can also be combined or interchanged in order to provide other implementations.

In the following description, the density is defined as the weight per unit volume of the body compared to the weight per unit volume of pure water at 4° C. Thus, the density in the following description is a unitless quantity.

Furthermore, in the following description, “biodegradable” is understood to mean a compound which can be decomposed by microorganisms to give simple molecules or a compound which does not exhibit any specific toxicity to the environment.

Subsequently, in the following description, “external part” is understood to mean a surface which is found in contact with the environment external to the passenger compartment of the motor vehicle.

Moreover, the term “white light” is understood here as light exhibiting a spectrum having wavelengths within the visible region, that is to say of between 400 nm and 800 nm. The term white light can just as easily correspond to natural light coming from the sun as to artificial light coming from lamps emitting radiation having wavelengths in the visible region.

Conversely, “black light” is understood to mean, in the following description, an artificial light, the emitted radiation of which has wavelengths in the ultraviolet region, and preferably of between 315 nm and 400 nm.

Furthermore, “sludge” is understood to mean, in the following description, aqueous washing liquors containing the components of the composition in solution or in suspension.

Finally, in the following description, “dirt” is understood to mean organic or inorganic contaminants which may be deposited on the external part of the windscreen of the vehicle, these contaminants being able to be solids or non-solids.

With reference to FIGS. 1 and 2, there is represented a front face of a motor vehicle 7. This front face exhibits in particular a windscreen 9 equipped with wiper blades 5 which make it possible, for example, to evacuate rainwater, dew or condensation present on the external part of this windscreen 9 in order to guarantee good conditions of visibility to the user of this motor vehicle 7.

In these figures, a composition 1 making it possible to show the wiping defects 3 of the wiper blade 5 is deposited as a layer on the windscreen 9 of the said motor vehicle 7. This composition 1 makes it possible in particular to determine the state of wear of the wiper blades 5 by showing the wiping defects 3 of these blades. This is because, when a wiper blade 5 is worn out, it leaves marks, such as streaks, chattering marks and also a veil when it passes over the windscreen 9. However, such marks are not always easily detectable during monitoring of the state of wear of the wiper blades 5 by a specialist in motor vehicle repair, for example.

In order to make it easier to detect the state of wear of the wiper blades 5, the composition 1 comprises a tracer compound 11 which makes it possible to bring to light the wiping defects 3 of the wiper blade 5. This is because the composition is deposited as a layer over the whole of the windscreen 9 of the motor vehicle and is subsequently swept away by the wiper blades 5. In the event of wear of these wiper blades, the tracer compound 11 remains on the regions of the windscreen 9 swept by the part of the wiper blade 5 exhibiting signs of wear and thus makes it possible to bring to light a wiping defect 3 on the windscreen 9. In order to provide sufficient adhesion to the windscreen 9 of the motor vehicle 7 to bring about the appearance of the wiping defects 3, the composition 1 exhibits a density of between 0.75 and 1.25 at 20° C., and a viscosity of between 0.001 and 1.5 Pa·s at 20° C. This is because such physicochemical properties prevent the sliding by gravity of the composition 1 over the windscreen 9.

According to the specific embodiment of FIG. 1, the tracer compound 11 of the composition 1 is a powder. Advantageously, the powder, once deposited on the windscreen 9, is opaque. According to this specific embodiment, the powder exhibits a white colour. However, according to other embodiments not represented here, the powder can exhibit any colour perceptible by sight by simple irradiation with white light. Such colours are ideally chosen in order to contrast with the windscreen 9 in order to easily show the wiping defects 3. Thus, yellow-coloured powders, or also orange-coloured powders, for example, can be used as tracer compound 11.

Furthermore, in order to maintain the integrity of the windscreen 9, and in particular in order to prevent scratches, the tracer compound 11 in the powder form exhibits a hardness which is less than the hardness of the windscreen 9.

Furthermore, in order to demonstrate the wiping defects, and more specifically the cracks which may be present in the blade rubber of the wiper blade 5, the tracer compound 11 in the powder form exhibits a particle size of less than 1 μm and preferably of less than 500 nm. This is because, if the powder exhibits a particle size of greater than 1 μm, it is possible for the particle to be able to be stuck in the blade rubber at the defect, such as a crack, for example, and to harm the effectiveness of the detection of the wiping defects 3. According to the specific embodiment of FIG. 1, the powder constituting the tracer compound 11 exhibits a particle size of between 1 nm and 250 nm.

Furthermore, according to the specific embodiment of FIG. 1, the wiping defects 3 brought to light by the composition 1 correspond to streaks. According to this specific example, the state of wear of the wiper blades 5 seems to require the replacement of the blades.

Advantageously, the tracer compound 11 of the composition 1 is biodegradable. More particularly, the composition 1 after use can be washed off and thus evacuated in the form of sludges, for example, and these sludges do not exhibit any toxicity with regard to the environment. The tracer compound 11 can, for example, be composed of a cellulose powder, of an inorganic powder or also of a biodegradable fluorescent polymer.

Furthermore, the composition 1 which makes it possible to detect the wiping defects 3 can be present in an aerosol in order to facilitate the deposition thereof as a layer on the windscreen 9 of the motor vehicle 7.

According to the specific embodiment of FIG. 2, the tracer compound 11 constituting the composition 1 is a liquid. According to this specific embodiment, the tracer compound 11 is a fluorescent liquid and the windscreen 9 of the motor vehicle 7 represented in this figure is illuminated by a lamp which emits wavelengths in the ultraviolet region in order to thus activate the fluorescence of the tracer compound 11. Preferably, the lamps used are “black light” lamps, that is to say lamps which emit radiation having wavelengths lying in the near ultraviolet region, and more particularly between 315 nm and 400 nm. The use of such a tracer compound 11 makes it possible to keep the windscreen 9 clean after the determination of the state of wear of the wiper blades 5 as such a compound is generally transparent when it is irradiated by wavelengths within the visible region. Advantageously, such a tracer compound 11 does not have to be washed off after verification of the presence of wiping defects 3.

According to the specific embodiment of FIG. 2, the composition 1 shows wiping defects 3 on the windscreen 9. These wiping defects 3 correspond to chattering movements of the wiper blades 5. According to the example represented in FIG. 2, the composition 1 shows that it is necessary to replace the wiper blades 5 in order to retain good conditions of visibility in the event of rain, for example.

According to another embodiment not represented here, the tracer compound 11 can be a coloured liquid, that is to say a liquid visible to the naked eye when it is exposed to white light.

According to another embodiment not represented here, the tracer compound 11 of the composition 1 is a foam. According to this embodiment, the tracer compound 11 can be coloured or fluorescent.

The present invention also relates to a method for determining the state of wear of a wiper blade 5. With reference to FIG. 3, the method comprises a stage of deposition E1 of a composition 1 which makes it possible to show the wiping defects 3 on the windscreen 9 of the motor vehicle 7 as described above. The method subsequently employs a stage of actuation E3 of the wiper blades 5 of the motor vehicle 7 so that they carry out at least one to-and-fro movement over the windscreen 9, and preferably three to-and-fro movements. During this actuation stage E3, the composition 1 deposited on the windscreen 9 during the deposition stage E1 is completely or partially swept away by the wiper blades 5 according to their state of wear. The method subsequently employs a stage of verification E5 of the presence of traces, showing the sweeping defects 3, optionally left by the wiper blades 5 on the windscreen 9 of the motor vehicle 7. This is because, if the wiper blades 5 exhibit wear defects, for example, the composition 1 will not be completely swept away during the actuation stage E3 and streaks (as represented in FIG. 1) or chattering marks (as represented in FIG. 2), corresponding to wiping defects 3, can appear, for example. This verification stage E5 makes it possible to evaluate the state of wear of the wiper blades 5 and to rapidly determine if it is necessary to replace them.

With reference to FIG. 4, there is represented a block diagram of a method for determining the state of wear of a wiper blade 5 according to a first embodiment. In order to improve the detection of the wiping defects 3, it is recommended to deposit the composition 1 on a clean windscreen 9. Thus, the method additionally comprises a prior stage E0 of cleaning the windscreen 9 of the motor vehicle 7. This prior cleaning stage E0 is carried out before the deposition stage E1. This is because the presence of dirt on the windscreen 9 can be harmful to the adhesion of the composition 1 to the latter. According to this first embodiment, the other stages of the method are subsequently carried out as described above.

With reference to FIG. 5, there is represented a block diagram of a method for determining the state of wear of a wiper blade 5 according to a second embodiment. According to this second embodiment, the tracer compound 11 is a coloured element visible when it is irradiated with wavelengths lying in the visible region. More particularly, the tracer compound 11 of the composition 1 is in the form of a powder. According to this second embodiment, the stage of verification E5 of the presence of traces is carried out in direct visual fashion after the stage of actuation E3 of the wiper blades of the motor vehicle 7. The windscreen 9 at the time of this stage of verification E5 according to this second embodiment corresponds to that represented by FIG. 1.

Furthermore, according to this embodiment, the composition 1 is present in an aerosol exhibiting a spray nozzle. The deposition stage E1 is carried out by spraying the composition 1 over the windscreen 9. Thus, a substantially homogeneous layer of the composition 1 is deposited on the windscreen 9. Advantageously, during the spraying of the composition 1 over the windscreen 9, the spray nozzle of the aerosol is at a distance of approximately 15 cm from the windscreen 9.

As the composition 1 exhibits a colour, it is necessary to remove it from the windscreen 9 after the verification stage E5 which makes it possible to determine the state of wear of the wiper blades 5 in order to guarantee a good state of cleanliness of the windscreen 9 and good conditions of visibility for the user of the motor vehicle 7. To this end, the method additionally comprises, according to this second embodiment, a final stage E7 of cleaning the windscreen 9 of the motor vehicle 7. Advantageously, this final cleaning stage E7 is carried out by spraying a liquid, such as water, for example, over the windscreen 9 of the motor vehicle 7. Furthermore, the tracer compound 1 is biodegradable, that is to say that the washing sludges produced during the final stage E7 do not exhibit any toxicity towards the environment.

With reference to FIG. 6, there is represented a block diagram of a method for determining the state of wear of a wiper blade 5 according to a third embodiment. According to this third embodiment, the composition 1 which makes it possible to show the wiping defects 3 comprises a tracer compound 11 in the form of a fluorescent liquid. According to this third embodiment, the method additionally comprises a stage of irradiation E4 at least of a detection region of the windscreen 9 of the motor vehicle 7 in order to activate the fluorescence of the tracer compound 11. This irradiation can, for example, be carried out using a portable “black light” lamp. In this case, the specialist in motor vehicle repair, for example, exposes different regions of the windscreen 9 to the radiation emitted by this lamp in order to activate the fluorescence of the tracer compound 11, thus making it possible to implement the stage of verification E5 of the presence of wiping traces. The use of such a tracer compound 11 makes it possible to detect different wiping defects 3, such as, for example, chattering movements of the wiper blades 5 corresponding to the wiping defects 3 represented in FIG. 2.

According to a preferred manner of this third embodiment, and optionally, the method for determining the state of wear of a wiper blade 5 moreover comprises an additional stage E2 in which the motor vehicle 7 is placed in a dark room in order to carry out the stage of irradiation E4 of the windscreen 9 of the motor vehicle 7 in order to detect the tracer compound 11. Advantageously, the additional stage E2 makes it possible to have a comprehensive view of the windscreen 9 of the motor vehicle 7. Furthermore, this additional stage E2 makes it possible to see the effectiveness of the wiper blades 5 during their operation both during an upward movement and during a downward movement. Thus, some minor wiping defects 3 can be easily detected.

According to this third embodiment, the final cleaning stage E7 is not necessary as the tracer compound 11 is transparent to white light. Thus, it cannot interfere with the conditions of visibility and thus driving safety.

With reference to FIG. 7, there is represented a block diagram of a method for determining the state of wear of a wiper blade 5 according to a fourth embodiment. According to this fourth embodiment, the composition 1 which makes it possible to show the wiping defects 3 comprises a tracer compound 11 in the form of a foam.

According to this embodiment, the foam is fluorescent. Advantageously, the method carries out the additional stage E2 in which the motor vehicle 7 is placed in a dark room and the wiping defects 3 are revealed during the irradiation stage E4. This irradiation stage E4 is carried out by irradiation of the windscreen 9 of the motor vehicle 7 with radiation exhibiting a wavelength ideally of between 315 nm and 400 nm in order to activate the fluorescence of the tracer compound 11. Furthermore, the method according to this fourth embodiment comprises the final cleaning stage E7. This is because it is possible for the foam, on drying, to leave marks on the windscreen of the motor vehicle 7. These marks can interfere with the visibility of the user and thus damage driving safety.

According to another embodiment not represented here, the tracer compound 11 can be in the form of a foam visible to the naked eye. In this case, the stage of verification E5 of the presence of traces is carried out in direct visual fashion after the stage of actuation E3 of the wiper blades of the motor vehicle 7.

The exemplary embodiments set out above are described by way of illustration and without limitation. This is because it is entirely possible for a person skilled in the art to spray the composition 1 over the windscreen 9 of the motor vehicle 7 directly without requiring the use of an aerosol without departing from the scope of the present invention. Furthermore, a person skilled in the art can entirely use a tracer compound 11 exhibiting phosphorescence properties without departing from the scope of the present description.

Thus, the determination of the state of wear of the wiper blades 5 of a motor vehicle 7 in a rapid and easy manner is possible by virtue of the use of a composition 1 comprising a tracer compound 11 as described above.

The state of wear of the wiper blades can also be determined via a telephone application. By taking a photograph of the windscreen after a washing and then wiping cycle via the telephone application, the latter evaluates the degree of wear of the wiper blades as a function of the wiping quality of the windscreen.

This is because, if the blade rubber exhibits traces of wear, such as cracks, for example, the washing liquid remains on the windscreen at the point of passage of the trace of wear of the blade rubber, thus damaging the wiping quality. This wear is demonstrated via the application, which indicates to the user the need to replace the wiper blades. This evaluation can also be combined with other information present in the application, such as the date of replacement of the blades, the number of wiping cycles, the noise, the weather, and the like.

The determination of the state of wear of the wiper blades via a telephone application can also be carried out by directly taking a photograph of the profile of the blade rubber.

In this alternative form, the determination of the state of wear of the wiper blades will be based in particular on the deformation of the profile of the blade rubber.

If the profile of the blade rubber is deformed in the free state, that is to say in the position not supported on the windscreen, then the application will indicate, as a function of the degree of deformation of the blade rubber, whether the replacement of the wiper blades is required and, conversely, if the profile of the blade rubber is not deformed in the position not supported on the windscreen, then the application will indicate that the wiper blades are in accordance and do not have to be changed.

The determination of the state of wear of the wiper blades can, in an alternative or combined manner, be based on the degree of wear of the lip of the blade rubber and/or of its coating.

In the same way as the alternative form described above, the determination of the state of wear of the wiper blades thus described can be combined with other information present in the application, such as the date of replacement of the blades, the number of wiping cycles, the noise, the weather, and the like.

1. A composition that facilitates showing the wiping defects of a wiper blade for a motor vehicle, to determine the state of wear of the wiper blade, the composition comprising:
a tracer compound that brings to light the wiping defects of the wiper blade and exhibits a density of between 0.75 and 1.25 at 20° C., and a viscosity of between 0.001 and 1.5 Pa·s at 20° C.,
wherein the composition is deposited as a layer on a windscreen of the motor vehicle.

2. The composition according to claim 1, wherein the tracer compound is a liquid.

3. The composition according to claim 2, wherein the tracer compound is a fluorescent liquid.

4. The composition according to claim 1, wherein the tracer compound is a powder.

5. The composition according to claim 4, wherein the tracer compound exhibits a particle size of between 1 nm and 250 nm.

6. The composition according to claim 1, wherein the tracer compound is a foam.

7. The composition according to claim 1, the tracer compound is biodegradable.

8. A method for determining the state of wear of a wiper blade comprising:
deposition of a composition that facilitates showing wiping defects on the windscreen of the motor vehicle according to claim 1;
actuation of the wiper blades of the motor vehicle, the blades being configured to carry out at least one to-and-fro movement over the windscreen; and
verification of the presence of traces, showing the wiping defects, left by the wiper blades on the windscreen of the motor vehicle.

9. The method for determining the state of wear of a wiper blade according to claim 8, further comprising a prior stage of cleaning the windscreen of the motor vehicle, said prior cleaning stage being carried out before the deposition stage.

10. The method for determining the state of wear of a wiper blade according to claim 8, wherein the composition comprises a tracer compound in the form of a fluorescent liquid and wherein the method additionally comprises a stage of irradiation at least of a detection region of the windscreen of the motor vehicle in order to activate the fluorescence of the tracer compound.

11. The method for determining the state of wear of a wiper blade according to claim 10, further comprising an additional stage in which the motor vehicle is placed in a dark room to carry out the stage of irradiation of the windscreen of the motor vehicle in order to detect the tracer compound.

12. The method for determining the state of wear of a wiper blade according to claim 8, wherein the composition comprises a tracer compound in the form of a powder and wherein the stage of verification of the presence of traces is carried out in direct visual fashion after the stage of actuation of the wiper blades of the motor vehicle.

13. The method for determining the state of wear of a wiper blade according to claim 8, wherein the composition comprises a tracer compound in the form of a foam and wherein the stage of verification of the presence of traces is carried out in direct visual fashion after the stage of actuation of the wiper blades of the motor vehicle or by irradiation of at least one detection region of the windscreen of the motor vehicle in order to activate the fluorescence of the tracer compound.

14. The method for determining the state of wear of a wiper blade according to claim 8, further comprising a final stage of cleaning the windscreen of the motor vehicle, the said final stage being carried out after the stage of verification of the presence of traces.
